(19) United States
(12) Patent Application Publication
(10) Pub. No.: US 2025/0358297 A1
(43) Pub. Date: Nov. 20, 2025

(54) AUTOMATED SUMMARIZATION OF NETWORK SECURITY INVESTIGATIONS

(71) Applicant: Arctic Wolf Networks, Inc., Eden Prairie, MN (US)

(72) Inventors: Hazem Mohamed Ahmed Soliman, Toronto (CA); Chris Douglas Kraft, Scottsdale, AZ (US); Marcio Lopes Larroyd, Kitchener (CA); Kenneth D. Ray, Enumclaw, WA (US); Syed Azfar Hussain, Nepean (CA); Daniel Schiappa, Windermere, FL (US); Michael Elliott Mylrea, Delray Beach, FL (US)

(21) Appl. No.: 19/206,307

(22) Filed: May 13, 2025

Related U.S. Application Data
(60) Provisional application No. 63/647,359, filed on May 14, 2024.

(51) Int. Cl. H04L 9/40

(52) U.S. Cl. CPC H04L 63/1416

(57) ABSTRACT

In some implementations, a cybersecurity system is provided for summarizing network security investigations. The system receives a request to summarize an investigation sequence performed in response to a computer security incident, retrieves tokenized elements that correspond to the investigation sequence, and provides the tokenized elements to a large language model (LLM) for translation into a data operation format. The system receives, from the LLM, and for each tokenized element, a corresponding translated data operation. For each translated data operation, the system submits the translated data operation for execution by a data source, and receives a corresponding data operation response. The system performs a summarization process of the investigation sequence, and outputs a natural language summarization.

### CROSS-REFERENCE TO RELATED APPLICATIONS

This application claims the priority benefit of U.S. Provisional Patent Application No. 63/647,359, filed May 14, 2024, the entirety of which is incorporated herein by reference.

### TECHNICAL FIELD

This specification generally relates to automated summarization and explanation of network security investigations, using artificial intelligence-based techniques.

### BACKGROUND

Cybersecurity involves the protection of systems, networks, and programs from digital attacks. Such digital attacks (also referred to as cyberattacks) are generally directed to accessing, changing, or destroying sensitive information, or otherwise interrupting operational processes. Various cybersecurity platforms have been implemented to monitor computer networks and devices, to detect potential cyberattacks and other threats, and to facilitate the performance appropriate response actions.

In general, traditional security operations centers (SOCs) often employ opaque methodologies, where the rationale and actions taken during an incident's resolution may be unclear to non-specialists. Further, the application of artificial intelligence (AI) can lack explainability, especially with respect to generative AI that is probabilistic, non-deterministic, and that lacks memory or state. This lack of transparency can hinder trust and can leave non-specialists without a clear understanding of the security threats they face and how such threats are being mitigated (e.g., the actions being performed by the SOC), and how the AI arrived at its mitigation recommendation.

### SUMMARY

This document generally describes computer systems, processes, products, and devices for performing an automated summarization and explanation of network security investigations, using artificial intelligence-based techniques. The present technology can provide informative, transparent, and efficient security threat detection and response within an organization's SOC.

With respect to investigation processes, a traditional approach involves a manual review of logs, a manual querying of multiple systems, and a manual construction of incident timelines, whereas the present technology involves an automated summation of investigation sequences using large language models (LLMs), thereby translating security data into natural language.

With respect to data silos, a traditional approach involves switching between different tools and interfaces to gather information, whereas the present technology involves a unified interface through a data gateway that communicates with multiple data sources, and that normalizes response formats.

With respect to providing context in alerts, a traditional approach involves rule-based enrichment with static, predefined rules, whereas the present technology involves a dynamic mapping of data operations to security insights with confidence scores based on corroborating evidence.

With respect to establishing causality, a traditional approach involves a manual correlation of events across time, whereas the present technology involves a temporal reasoning algorithm that automatically establishes causal relationships between security events.

With respect to reporting, a traditional approach involves standard reports regardless of user expertise, whereas the present technology involves a natural language summarization that adaptively adjusts technical complexity based on a detected expertise level of a user.

With respect to information sharing, a traditional approach involves manual redaction and information control, whereas the present technology involves an automated determination of detail level based on user role and permissions.

With respect to investigation workflows, a traditional approach involves text-based tickets with limited interactivity, whereas the present technology involves a multi-turn conversational interface supporting dynamic inquiries about security incidents.

With respect to potential knowledge loss between incidents, a traditional approach involves case-by-case handling with limited knowledge transfer, whereas the present technology involves the storage of summarizations with metadata identifying patterns correlated with known threat actor techniques.

With respect to an investigation approach, a traditional approach involves a manual determination of next steps, whereas the present technology involves an automatic suggestion of next steps.

In general, the present technology can enable non-specialists (e.g., customers of a computer security service) to submit inquiries and to receive responses about specific security tickets, facilitating a deeper understanding of the nature of a security threat, both in a general sense (e.g., for common types of security threats encountered in a computer network) and specifically (e.g., for a particular security incident). With respect to the present technology, a security ticket generally refers to a document or record that refers to a potential or actual security incident, alert, request, or event that warrants an action or response. Non-specialists can review and analyze tokenized data relevant to their inquiry, thereby gaining insights into how similar incidents are typically handled, and the specific actions taken in their own case. Data tokenization generally refers to a data transformation process in which data is transformed into a standard format that enables uniform analysis, processing, and/or ingestion of data by a computer. With respect to the present technology, the tokenized data can pertain to curated queries and/or actions (e.g., queries and/or actions that have been submitted and/or performed for past cybersecurity alerts and events, and that have been tokenized and stored).

An explainability feature can be provided to enable non-specialists to understand the work of SOC analysts. The explainability feature can be achieved by allowing the non-specialists to rerun tokenized queries themselves, offering a transparent view of a decision-making process, including how threats are identified and mitigated. This feature not only reinforces trust, but also educates on the intricacies of cybersecurity operations.

Generalized responses about potential or hypothetical computer-based attacks can be provided, helping non-specialists understand broader security concepts and the typical responses orchestrated by an SOC. Further, non-specialists can be informed about proactive measures taken on their behalf that did not necessarily result in a security ticket, thereby providing peace of mind and demonstrating the preventative capabilities of a security service/platform. Thus, non-specialists can be provided with an understanding of the SOC's continuous efforts to safeguard their systems, and an understanding of the sensitivity and thoroughness of the SOC's security monitoring processes.

In some implementations, a cybersecurity system can be configured to perform operations for summarizing network security investigations. The operations can include receiving a request to summarize an investigation sequence performed in response to a computer security incident; retrieving a set of tokenized elements that correspond to the investigation sequence; providing each tokenized element in the set of tokenized elements to a large language model (LLM) for translation into a data operation format; receiving, from the LLM, and for each tokenized element in the set of tokenized elements, a corresponding translated data operation; for each translated data operation in a set of translated data operations, (i) submitting the translated data operation for execution by a data source, and (ii) receiving a corresponding data operation response; performing a summarization process of the investigation sequence, based at least in part on the set of tokenized elements and on a set of corresponding data operation responses; and outputting a natural language summarization of the investigation sequence, based on the summarization process.

Other implementations of this aspect include corresponding computer methods, and include corresponding apparatus and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other implementations can include any, all, or none of the following features. The LLM can be refined such that the LLM is configured to translate natural language commands into the data operation format. The refining can be based at least in part on a data schema of security incident data maintained by the data source, a data operation syntax employed by the data source, and data that represents historical security investigations and their associated data operations. The set of tokenized elements can include natural language questions and/or natural language actions. The summarization process can include providing each data operation response in the set of data operation responses to the LLM for translation into a corresponding natural language response; aggregating the set of tokenized elements and a corresponding set of natural language responses; providing the aggregated tokenized elements and corresponding natural language responses to the LLM for summarization; and receiving, from the LLM, the natural language summarization of the investigation sequence. A technical complexity of the natural language summarization of the investigation sequence can be adaptively adjusted by the LLM to reflect a technical expertise and/or security privileges of a user from whom the request to summarize an investigation sequence is received. The request to summarize the investigation sequence performed in response to the computer security incident can be received through a visual interface, and the natural language summarization of the investigation sequence can be returned through the visual interface. The visual interface can be a text service that supports multi-turn conversations about the computer security incident. The corresponding data operation response can be mapped to a corresponding security insight. The natural language summarization of the investigation sequence can be stored, along with information that pertains to a case type of the investigation sequence. The information that pertains to the case type of the investigation sequence can include a typical predicted analysis pattern for the case type.

The systems, devices, program products, and processes described throughout this document can, in some instances, provide one or more of the following advantages. The technology described in this document can provide enhanced transparency and explainability by converting complex query outputs into natural language summaries. Incident responses can be accelerated by leveraging a retrieval augmented generation (RAG) architecture that includes relevant stored queries that are linked to specific threat patterns. In response to the detection of a security incident, an immediate and relevant response can be triggered. Dynamic adaption and learning can occur through the continual refinement of a data source of queries and incident-handling procedures based on real-time data, ensuring that a security operations center (SOC) evolves with the security threat landscape and the environment it protects. Consumers of security information (e.g., customers of a computer security service) can be empowered through an interactive aspect that allows the security information consumers to engage with SOC processes, to run queries, and to check the work of security analysts. Predictive and preventative insight can be provided for security measures that were taken but that did not generate tickets, thus providing visibility into proactive defenses that are in place, and highlighting the SOC's preventative strategies. Through explainable AI-generated summaries and the ability to interact with the SOC's decision-making process (e.g., a process that is followed for determining whether a ticket should be issued, or another sort of security-related decision), consumers of security information can understand and trust in the SOC's capability to maintain a robust security posture.

Other features, aspects and potential advantages will be apparent from the accompanying description and figures.

### DESCRIPTION OF DRAWINGS

FIG. 1 depicts an example process flow for generating tokenized queries, actions, and results.

FIG. 2 depicts an example process flow for generating responses based on user input.

FIG. 3 depicts an example process flow for generating an automated summarization of a network security investigation.

FIG. 4 depicts an example of data in a network security investigation summary scenario.

FIG. 5 depicts a conceptual feature layout of a cybersecurity incident management system.

FIG. 6 is a schematic diagram that shows an example of a computing system.

Like reference symbols in the various drawings indicate like elements.

### DETAILED DESCRIPTION

This document describes technology that can perform an automated summarization and explanation of network security investigations, using artificial intelligence based techniques. The present technology incorporates a retrieval augmented generation (RAG) architecture and a tokenization framework to enhance real-time security threat detection and response, and to provide artificial intelligence (AI) model optimization.

In general, a consumer of security information and services (e.g., a customer or another sort of non-specialist with respect to computer/network security) may have various concerns when a security incident occurs, such as what actions have been taken to resolve the incident, what actions can be performed by the consumer themselves, how to interpret a ticket related to the security incident, what value is being provided by a security operations center (SOC), and so forth. A potential hurdle to addressing these concerns may be an expertise gap—that is, the consumer's understanding of security-related issues and technology may be limited. To overcome this potential hurdle, a large language model (LLM) and various data science practices can be used to guide a non-specialist consumer of security information and services to provide clarity with respect to the security incident.

At a high level, a security operations center can operate a security platform that includes various technical features to facilitate the provision of security information and services. For example, contextual-driven detection and prediction can be used to combine behavior patterns or heuristics, to better understand how to distinguish normal operations from anomalous operations. With that, a more proactive to testing and enumerating vulnerability in the data can be applied, such as chaos engineering which runs simulated tactics, techniques, and procedures (TTPs) against the consumer's computer network environment to understand what vulnerabilities are most likely to be exploited. As another example, real-time tokenization of security data (e.g., logs, alerts, network traffic) can be performed, where each data element is converted into a standardized token format for uniform processing and analysis.

Thus, the present technology employs a contextually driven detection methodology by analyzing behavioral patterns across event distributions to establish baseline normality and anomaly parameters. Proactive vulnerability enumeration through automated chaos engineering executes simulated TTPs against network environments to identify exploitable attack vectors before adversaries discover them. Real-time security data tokenization can be employed to standardize heterogeneous inputs for uniform processing. Integration with LLMs represents a paradigm shift through the creation of a self-evolving defense mechanism that continually adapts to emerging threat patterns.

Further, the security platform can include a dynamic machine learning and adaptation mechanism. For example, a dynamic learning component of the security platform can update its data source of tokenized queries, actions, and results based on outcomes of current cases, effectively adapting over time to evolving threats and improving future responses and mitigation strategies. Further, analyst queries and actions can be distilled into a tokenized format, based on an examination of logs, execution of queries, and mitigation actions. For example, the actions can be assessed and vectorized as a function of how these actions created improved time to value, how these actions improved reduction in value at risk, and/or how these actions improved mean time to process a ticket based on a measure of optimal kill chain tasking. A detailed, auditable trail can be provided of decisions and actions taken during incident response. An artificial intelligence (AI) model used by the dynamic machine learning and adaptation mechanism can continuously improve via an integrated feedback mechanism (e.g., based on feedback functions built into a retrieval augmented generation (RAG) component) that uses results from past and current cases to refine and optimize tokenization algorithms and response strategies, thus ensuring that the security platform continuously evolves to address new and emerging threats effectively.

Further, the security platform can include a case-based query and response system. To improve predictive detections of threats, for example, the case-based query and response system can use tokenized security events to generate queries and responses based on historical security threat cases, and on cases that apply continuous testing to environment. A knowledge base that stores past incidents as templates of tokenized queries and actions can enable the system to match current incidents with historical data for improved threat recognition and response strategies.

Further, the security platform can include a dynamic threat detection and response engine. The dynamic threat detection and response engine, for example, can automate various tactics, techniques, and procedures (TTPs) by processing tokenized data to detect anomalies and potential threats. The processing and detection can involve comparing against a data source of known threats and vulnerabilities, and automatically initiating assessment based on attack frameworks, as well as suggesting and/or automating predefined mitigation actions.

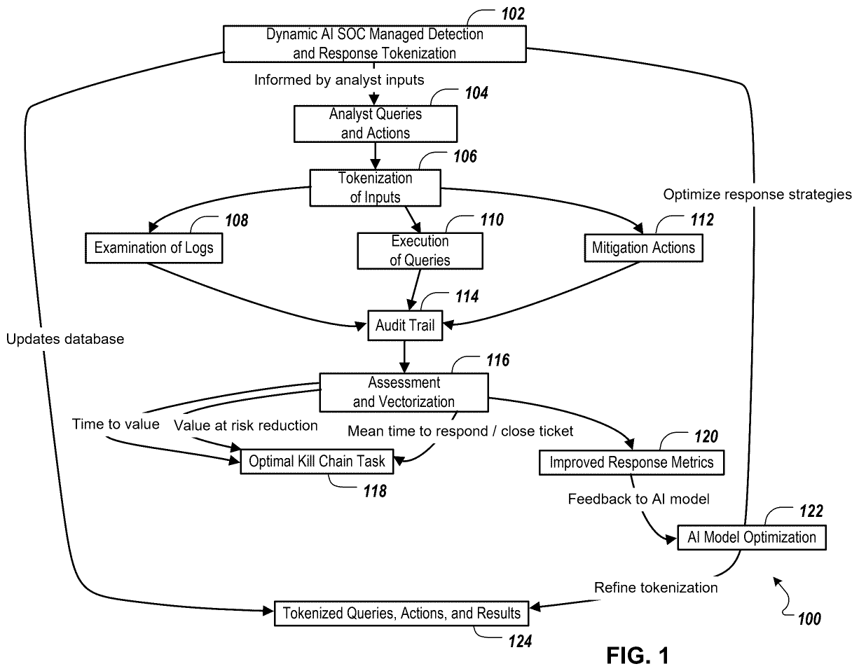

FIG. 1 depicts an example process flow 100 for generating tokenized queries, actions, and results. In general, the process flow 100 can provide a detailed audit trail of decisions and actions taken during incident response. Based on an audit trail, for example, an assessment and vectorization process can be employed to generate the tokenized queries, actions, and results.

At 102, a dynamic artificial intelligence (AI) security operations center (SOC) managed detection and response tokenization process is performed.

At 104, analyst queries and actions are processed. The analyst queries and actions can be informed by analyst inputs.

At 106, a tokenization of inputs (e.g., the analyst queries and actions) is performed, including an examination of logs (at 108), an execution of queries (at 110), and mitigation actions (at 112). In general, tokenization can include converting data into a standard format that enables uniform analysis, processing, and/or ingestion of data. For example, telemetry data from different endpoint providers can each use different data formats, types of alerts, etc., and a tokenization process can involve transforming the telemetry data from the different endpoint providers into a same data format. The tokenization process, for example, can be an input processing process (e.g., a vectorized embedding process) for a transformer model, or another suitable data transformation process. The tokenization process can generally reduce the cardinality of the investigation steps and allow for the system to better understand the intent behind any given step.

At 114, an audit trail is determined, based on tokenized investigation steps. Data and logs and other security events are checked. Further, a determination of why the data/logs/security events were checked is performed as well as a determination of the outcomes of the checks. Further, additional research and validations are conducted, and tokenized actions are taken.

At 116, an assessment and vectorization process is performed on the audit trail. The vectorization process employs security-specific enrichment or transformation where telemetry (e.g., based on security logs, events, etc.) can first undergo domain-specialized filtering to extract security-relevant entities. A cybersecurity-trained embedding model can then transform this data into vector representations that preserve attack technique relationships between the various investigation steps, and their eventual outcomes. The system can generate composite embeddings with separate but interconnected subspaces for threat characteristics, network behaviors, and mitigation effectiveness. These vectors populate dual indices (detection and mitigation) using security-optimized hashing for rapid retrieval. This dynamic vector enrichment continuously updates embeddings through reinforcement learning from human feedback (RLHF) and reinforcement learning from AI feedback (RLAIF) to incorporate analyst feedback with machine scale context enumerated in historical data.

At 118, an optimal kill chain task is determined, based on the output of the assessment and vectorization process. In general, a kill chain can refer to actions taken to mitigate an adversary during a security incident (e.g., from an adversary performing reconnaissance, to gaining access, to performing a malicious action). Determining the optimal kill chain task can generally include evaluating the steps taken, the value of each step, the specific response actions taken, and the eventual final outcome. For example, determining the optimal kill chain task can involve determining a value at risk reduction, determining a mean time to process an alert or detection, and determining what the actual end user actions were needed and if the customer took them. The earlier that an indicator of compromise can be recognized, for example, the earlier an appropriate mitigation/response can be performed, thus facilitating proactivity.

At 120, improved response metrics (e.g., mean time to triage and resolve, percentage of alerts that do not need human interaction, a final efficacy and efficiency of an investigation process as determined by final outcomes, etc.) are determined, based on the output of the assessment and vectorization process.

At 122, artificial intelligence (AI) model optimization is performed. The AI model optimization, for example, can include providing feedback to the AI model based on the improved response metrics, such as reinforcing particular model weights and parameters so that the precision and recall performance of the model is improved, while improving mean time to triage, resolve, efficiency, and efficacy. If mean time to triage/resolve is improved but the value of the model's output decreases, for example, there may be reduced value in such optimizations. Optimized response strategies determined by the AI model, for example, can be provided to the detection and response tokenization process (at 102) as a feedback loop.

At 124, tokenized queries, actions, and results are generated. Generation of the tokenized queries, actions, and results, for example, can be performed based on data source updates from the detection and response tokenization process (at 102), and on refined tokenization received from the optimized AI model (at 122).

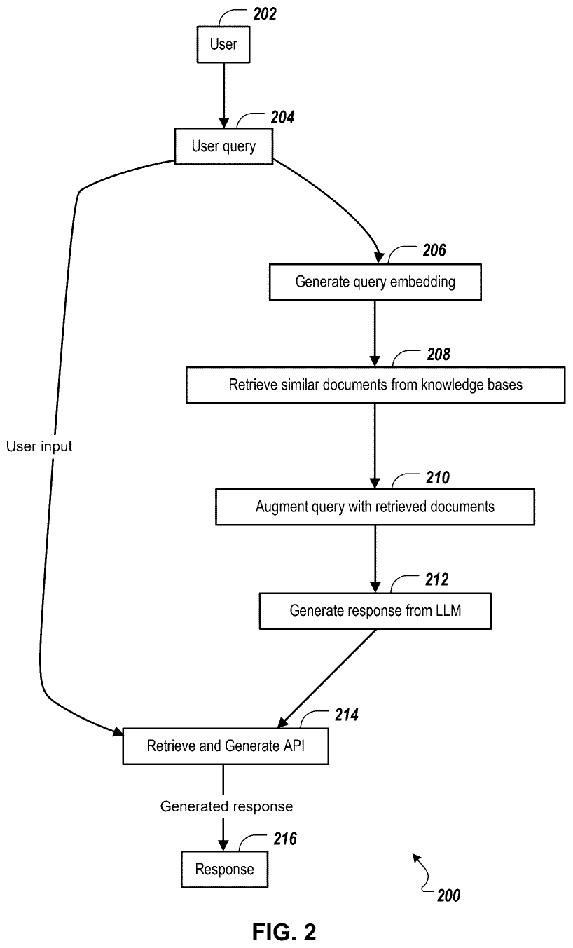

FIG. 2 depicts an example process flow 200 for generating responses based on user input. In this context, a user can be either the consumer or purchaser of security services, or an analyst who provides the security services. As shown in the example process flow 100, a user 202 provides a user query 204. For example, the user query 204 can include information about a network security-related event (e.g., a possible malware attack, a phishing message, a security alert, or another sort of event), along with a request for an action to be performed in response to the event. In the present example, the user query 204 can be submitted by the user through a computing terminal that is communication with the AI-driven cybersecurity threat detection and mitigation classifier system.

Upon receiving the user query 204, for example, an AI-driven system can perform various actions for processing the query and returning a response. At a high level, query embedding is generated at 206. In general, query embedding can include converting a text-based query into a numerical representation using an embedding model. The numerical representation of the text-based query (e.g., user query 204) can be used to measure distances and similarity between different queries. At 208, similar documents (e.g., documents that are related to the user query 204) are retrieved from knowledge bases (e.g., a knowledge base of a retrieval augmented generation (RAG) platform). At 210, the query is augmented with the retrieved documents from the knowledge bases. At step 212, a response is generated from a large language model (LLM). A retrieve/generate application programming interface (API) 214 can generate a response 216, based on the user query 204 and on the response generated from the LLM (e.g., at 212).

In general, retrieval augmented generation is a technique for enhancing the accuracy and reliability of generative artificial intelligence (AI) models with data retrieved from one or more external sources. For example, large language models (LLMs) can be used to respond to human queries, however the LLMs may lack specific knowledge about specific topics that are relevant to the queries. Thus, RAG-based techniques can be used to fill in possible gaps in responses generated by the LLMs, and to provide citable sources for details included in the responses-thus, providing users with a degree of transparency and verifiability that may not exist with LLMs alone.

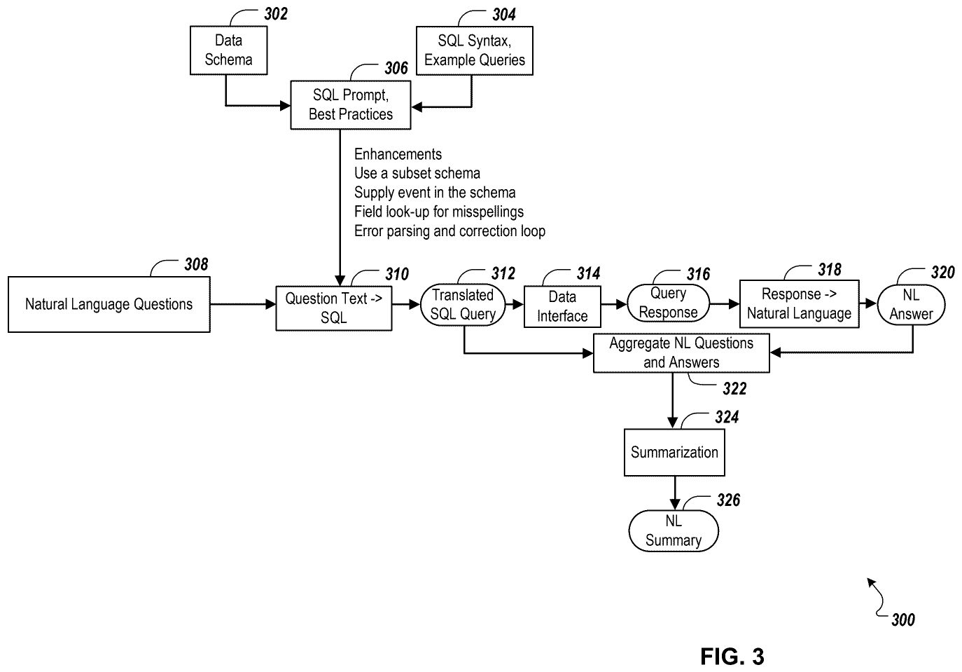

FIG. 3 depicts an example process flow 300 for generating an automated summarization of a network security investigation by a security platform. In general, the process flow 300 can be performed for explaining the steps taken by an analyst when investigating a security incident and for explaining the reasoning behind their conclusion. Such reasoning may not only be reflective of historical data but may reflect a continuous process of understanding the cause and effect, and the input and output capture in the historic data. Based on thousands of security investigations performed for a specific type of security case, for example, results of the investigations can be used to inform how an AI model generates responses for future security cases. The process flow 300 of the present example can include an offline phase and an online phase.

During the offline phase, a subject matter expert (e.g., a security analyst) can conduct a systematic identification of a specific, homogenous group of security incidents. The identification can leverage data and business metrics to pinpoint incidents that share common security threat characteristics or vectors, thereby forming a well-defined evidence group for the security incidents. For a particular evidence group (i.e., a cohesive group of incidents that share common security threat characteristics or vectors and that are similarly investigated), for example, a series of pertinent queries can be developed and subsequently stored. These queries can be tailored to unique attributes of the evidence group and can include specific criteria for aligning new incidents with the group. In general, the criteria can define the evidence group for the security incidents. For example, the criteria can include a set of filters for fields in the evidence group. A new incident can be assigned to the evidence group, for example, if it matches the set of filters. The security platform can be equipped with a targeted analytical framework configured to facilitate expedited and precise responses to familiar security threat patterns.

A general goal of the offline phase is to curate a sequence of steps used for investigating multiple different evidence groups. The offline phase can be executed by a subject matter expert supported by artificial intelligence (AI), for example, by identifying an evidence group, and then by adding and storing a sequence of relevant queries for investigating and/or handling security incidents that belong to the identified evidence group, in addition to group matching criteria. The sequence of relevant queries can generate a set of steps to determine, for a given batch of evidence, whether a ticket should be provided in response to a particular security incident.

As an example of actions performed during the offline phase (i.e., an offline curation workflow), a subject matter expert (e.g., a security analyst) may identify a homogenous group of security incidents (e.g., persistent secure shell (SSH) brute-force attacks). In the present example, the analyst reviews data showing many failed authentication attempts from many distinct internet protocol (IP) addresses targeting administrative accounts on demilitarize zone (DMZ) servers over a 72-hour period. Using temporal clustering and source attribution analysis, for example, the analyst determines that these attempts share common characteristics, such as identical timing patterns, similar IP geolocation properties, and consistent payload signatures. In the present example, the analyst then tags these attempts as a unified evidence group (e.g., labeled “Coordinated SSH Brute Force Campaign”), which can be used as a training set for a vector embedding model to learn the multidimensional relationships between attack timing, target selection, and technique variations-thereby generating a specialized region within a threat vector space that enables rapid identification of future instances of this attack pattern with high confidence.

In general, an offline curation workflow can include maintaining large dataset of security incidents, their annotations, as well as documentation that describes different types of incidents and their recommended investigation steps. A machine learning (ML) algorithm can be used to build evidence groups, where evidences within each group can be investigated similarly (e.g., by matching a same set of curated queries). A machine learning algorithm can be used to provide a summary explanation of the identified evidence groups, for optional review by a subject matter expert. An evidence group can then be converted into matching logic for cluster assignment (e.g., as a set of filters on the incident fields and values). Optionally, the subject matter expert can review and confirm the evidence group assignment logic. The set of curated queries can be added to the evidence group at hand (e.g., including a natural language question, and a corresponding programmatic query).

During the online phase, a real-time incident investigation can be conducted. In general, comprehensive and immediate exploration of relevant incident facets can be ensured by the security platform. Upon detection of a new security incident, for example, the security platform can autonomously execute pre-stored queries that correspond to a security incident's characteristics. After executing the pre-stored queries, results from the queries (e.g., in the form of a data table) can be aggregated and processed by an AI module. The AI module, for example, can be configured to transform technical data derived from the queries and their results into a natural language summary that explains the security incident and its resolution (or potential resolution).

The natural language summary clarifies the actions undertaken during the security incident's resolution and provides a detailed explanation of the underlying logic behind each procedural step and decision. Further, security information can be quickly provided by leveraging pre-configured queries for rapid execution. Dynamic workflow tracking paired with the generation of intelligible, explanatory summaries can increase the understanding and trust of non-specialists. Insight can be provided not only into the actions performed to resolve security incidents, but also the rationale behind these actions. The dual-phase workflow of the present example, which combines proactive strategic preparation with automated real-time execution and elucidation, can provide significant benefit to the operational capabilities of security operations centers (SOCs), fostering improved security management and increased consumer satisfaction.

Referring to the example process flow 300, at 302, a data schema is identified (at 302), and a data operation syntax (e.g., SQL, ElasticSearch Query, Kibana query language, or another suitable data operation syntax) is identified (at 304). The data schema, for example, can be a standardized format in which data of the security platform is maintained (e.g., as part of a tokenization process for the data). The data operation syntax, for example, can be a syntax that is used by a data storage system of the security platform to maintain network telemetry data, security incident data, alert generation data, and so forth. Optionally, the data operation syntax can include various example operations (e.g., queries, actions, etc.).

At 306, the data schema and the data operation syntax are aggregated, along with information that pertains to best practices for generating prompts for performing data operations. Optional enhancements can include use of a subset schema, supplying one or more events in the schema, field lookups for misspellings, error parsing and correction loops, etc.

At 310, the data schema, data syntax (e.g., SQL syntax, or another suitable data operation syntax), and best practices information are provided to a large language model (LLM) that is configured to translate natural language questions/commands into data operations that use the data schema and data operation syntax, and that follow the best practices for generating prompts. The LLM, for example, can undergo an artificial intelligence (AI) model optimization process (e.g., pre-process training, post-process training, and/or tuning) using the received data schema, data syntax, and best practices information.

In general, optimizing an LLM for a specific task or domain such as cybersecurity, may employ a layered approach involving several training, refinement, and adaptation techniques. Each of those techniques has a different level of complexity, customization, and compute cost. For example, training an LLM is typically an expensive operation, and thus the security platform may employ a pre-trained foundation model or other pretrained LLM, in combination with other less compute-intensive techniques for refining or otherwise improving performance of the LLM.

Various techniques for refining LLMs may include prompt engineering, fine-tuning optimizations, and orchestration steering. Prompt engineering may include the process of designing and refining the inputs (prompts) that are given to the LLM to guide the model toward producing accurate, relevant, and useful responses. Fine-tuning may include training the LLM on domain-specific data to improve its understanding, reasoning, and generation within that context. Such domain-specific data in the cybersecurity context may include security alerts, analyst notes, and incident reports. While RAG handles real-time retrieval of fresh knowledge, fine-tuning enhances the model's baseline capabilities, such as recognizing cybersecurity terminology or producing more structured, accurate responses, which may reduce the need for overly complex prompts. Together, fine-tuning and prompt engineering work in tandem: one improves the model itself, and the other optimizes how the model is used.

At 308, a set of tokenized elements (e.g., tokenized queries and actions) can be identified and provided to the LLM. In the present example, the set of tokenized elements can include a set of natural language (NL) questions/commands. The set of tokenized elements, for example, can be parsed to identify security-relevant entities and their relationships. The set of natural language questions/commands, for example, can pertain to a single security incident for which a security investigation has been performed (or is currently being performed). For example, when performing a security investigation, a security analyst can submit a series of questions over time to determine a cause of the security incident and/or to determine an appropriate response, and the submitted series of questions can be stored and then returned by the security platform in a batch, in response to a request. As another example, the security platform can maintain a mapping of security incidents (e.g., security incidents of an evidence group) to sets of questions that have generally been submitted for investigating similar security incidents in the past, and the security platform can return a set of questions that pertain to the particular security incident based on the mapping. Optionally, the set of natural language questions/commands can include a request for security information from an information consumer other than the security analyst (e.g., a consumer of a service provided by the security platform.)

In some implementations, each natural language question/commands in the set of natural language questions can be a curated query or curated action. In general, curated queries are queries that are linked to past cybersecurity alerts and events (e.g., questions that were previously prompted to and/or asked by analysts and/or customers, and that have been tokenized and stored). It will be appreciated that actions that have been performed in response to the cybersecurity alerts and events can also be curated (e.g., tokenized and stored).

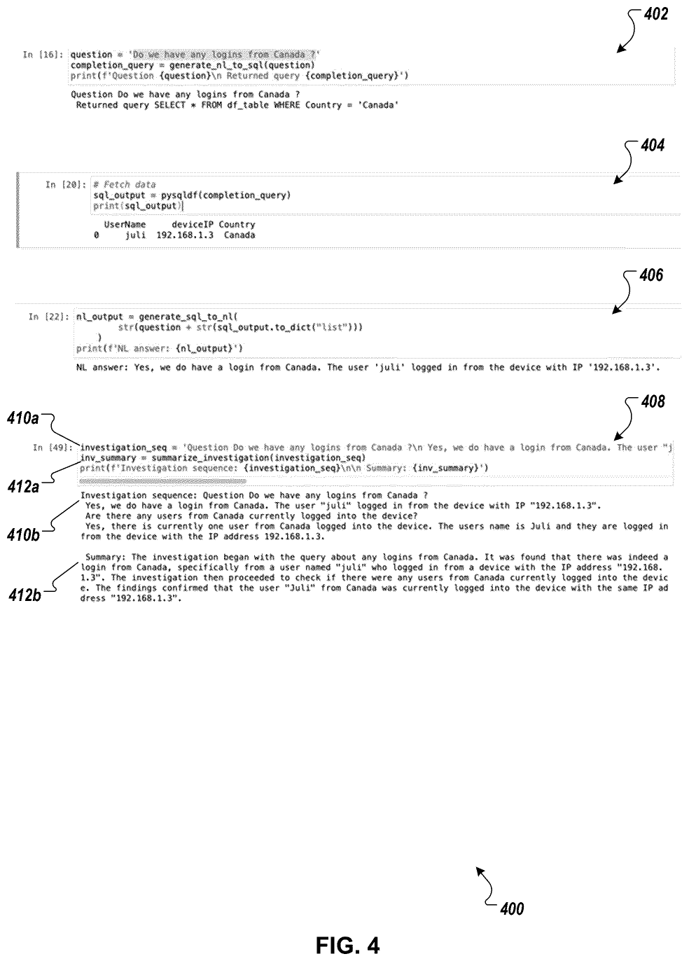

At 312, for each natural language question/command in the set of natural language questions/commands, the LLM can generate a translated data operation (e.g., a query operation, an operation to perform a specified action, or another sort of operation). Referring to FIG. 4, data example 402 shows a natural language query (e.g., “Do we have any logins from Canada?”), a command for the LLM to translate the natural language query to SQL (e.g., “completion_query=generate_nl_tosql (question)), and the translated SQL query (e.g., “SELECT*FROM df_table WHERE Country=‘Canada’”). As another example, the translated data operation can be an operation that involves another sort of data operation syntax (e.g., SQL, Elastic, Kibana, or another suitable data operation syntax), an operation that submits a call to an application programming interface (API), or another sort of information retrieval syntax for retrieving information from one or more data sources.

At 314, the translated data operation can be provided to a data interface. The data interface, for example, can be a unified interface (e.g., an application programming interface (API)) of a data gateway that enables queries and actions to be submitted to and executed by various different data sources. The unified interface, for example, can be configured to communicate with multiple different data sources and to normalize formats across the different data sources. In the present example, the translated SQL query (e.g., “SELECT*FROM df_table WHERE Country=‘Canada’”) can be provided to the data interface.

At 316, the data interface can generate a data operation response. For example, the data interface can submit the translated data operation (e.g., in an SQL format, or another data operation format) to a data source of the security platform. The translated data operation can be executed by the data source of the security platform, for example, and the resulting response can be output by the data source. Referring again to FIG. 4, data example 404 shows a submission of the translated SQL query to the data source (e.g., “sql_output=pysqldf(completion_query)”), and a query response (e.g., a table structure having the data fields “UserName,” “deviceIP,” and “Country,” with a single data record having the data field values “juli,” “192.168.1.3,” and “Canada”).

At 318, the data operation response can be provided to the LLM for translation into natural language. Referring again to FIG. 4, data example 406 shows a command for the LLM to translate a query response to natural language (e.g., “nl_output=generate_sql_to_nl(str(question+str(sql_output.to_dict (“list”)))), and a natural language answer (e.g., “Yes, we do have a login from Canada. The user ‘juli’ logged in from the device with IP ‘192.168.1.3’).

In some implementations, a data operation response can be mapped to a corresponding security insight (i.e., an actionable observation, derived from the analysis of security-related information, that enables the identification, prevention, or mitigation of security threats). Mapping the data operation response to the corresponding security insight, for example, can include dynamically assigning confidence scores to various candidate security insights in association with the data operation response, based on corroborating evidence across multiple heterogeneous data sources. A candidate security insight having a highest confidence score can be selected as the corresponding security insight, for example.

At 322, an aggregation can be performed of natural language questions, answers, and performed actions. Referring again to FIG. 4, data example 408 shows a command 410a to generate a natural language investigation sequence (e.g., a series of submitted queries/questions used to investigate a security incident), and output 410b that includes a sequential listing of the natural language questions and corresponding natural language answers included in the investigation sequence. Optionally, some or all of a conversation (e.g., a text-based conversation) that was performed over the security platform can be included in the aggregation. It will be appreciated that an investigation sequence may include a single data operation using a single data retrieval syntax for data accessible from a single data source, or may include multiple different data operations using multiple different data retrieval syntaxes for data accessible from multiple different data sources.

At 324, a summarization of the natural language investigation sequence can be generated (e.g., by the LLM). Referring again to FIG. 4, data example 408 shows a command 412a to generate the summarization of the natural language sequence (e.g., “inv_summary=summarize_investigation(investigation_seq)), and a resulting summarization 412b that summarizes, in natural language, the questions, answers, and actions used to investigate/resolve a security incident.

At 326, the summarization of the natural language investigation sequence can be output. For example, the summarization 412b can be included as part of a ticket that is transmitted to a consumer of security services provided by the security platform. As another example, the summarization 412b can be provided through a visual interface, such as a text service of the security platform (e.g., a chatbot) that supports multi-turn conversations about the investigation sequence. For example, the consumer of security services can submit an inquiry into the status of an ongoing or completed security investigation, and the security platform can generate and return a natural language summarization that pertains to the investigation. The natural language summarization (e.g., summarization 412b) can serve to inform non-specialists of the details of the security investigation in an understandable format. In some implementations, a suggestion of next investigative steps may be generated. For example, the summarization 412b can include a natural language summarization of a current status of the security investigation, and a natural language summarization of suggested next steps for continuing the security investigation.

In some implementations, the natural language summarization of the investigation sequence may include an explanation of causal relationships (if present) between successive operations of the investigation sequence. For example, a particular operation of the investigation sequence may not generate results data, which may lead a security analyst to pivot to another data source. As another example, a particular operation of the investigation sequence may identify a file that is then examined in further detail in a sandbox environment. A resulting natural language summarization of the security investigation, for example, can include an explanation of a relationship between the data operation results of a prior stage of the investigation sequence and the execution of a data operation for a subsequent stage of the investigation sequence. Determining the explanation of causal relationships, for example, can be performed by applying a temporal reasoning algorithm to establish the relationship between the various stages and data operation results.

In some implementations, the natural language summarization of the investigation sequence may include a prioritization of information based on relevance to the security incident. For example, data operations that are determined as being of greater relevance to the security incident can be prioritized (e.g., described in greater detail) in the natural language summarization, whereas data operations that are determined as being of lesser relevance to the security incident can be deprioritized (e.g., described in lesser detail) in the natural language summarization.

In some implementations, the natural language summarization of the investigation sequence may be adaptively adjusted in terms of technical complexity, based on a detected expertise of a platform user. The detected expertise of the platform user, for example, can be based at least in part on a user role. For example, if the platform user were to be a security analyst, the adjusted technical complexity of the natural language summarization can be a relatively complex summarization (with more technical details), whereas if the platform user were to be a non-specialist customer, the adjusted technical complexity of the natural language summarization can be a relatively simple summarization (with fewer technical details).

In some implementations, the natural language summarization of the investigation sequence can be stored by the security platform, along with information that pertains to a case type of the investigation sequence. The case type can generally refer to a class of similar security incidents that undergo similar investigation sequences (e.g., according to a classification algorithm that is configured to classify security incidents). The information that pertains to the case type, for example, can include a typical predicted analysis pattern for the case type (e.g., based on metadata identifying patterns that correlate with known threat actor techniques), and/or a typical usage of tokenized queries and/or actions for the case type. Saving the natural language summarization of the investigation sequence with the information that pertains to the case type, for example, can provide a security information consumer with an improved understanding of how a security incident was detected, what activities were performed when investigating/resolving the security incident, and what actions (if any) the consumer should take.

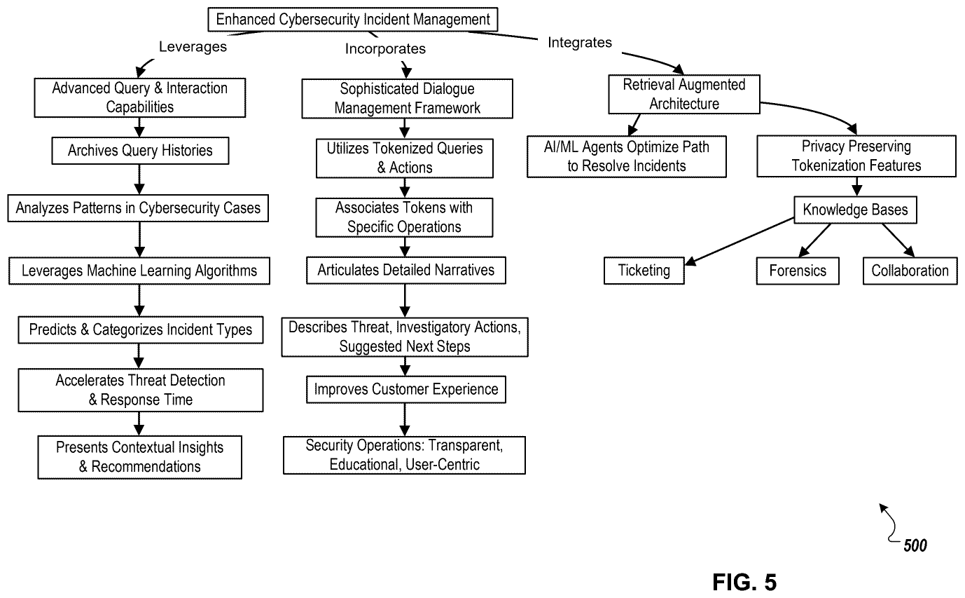

FIG. 5 depicts a conceptual feature layout 500 of a cybersecurity incident management system. In general, an artificial (AI) model architecture, and human augmented feedback loops are designed to enhance cybersecurity incident management through advanced query and interaction capabilities. The cybersecurity incident management system (e.g., a security platform or a portion thereof) archives comprehensive summaries of query histories, facilitating a refined analysis based on established patterns that have been typically observed in specific classes of cybersecurity cases. By leveraging AI algorithms and AI/ML agents, for example, the cybersecurity incident management system can predict and categorize incident types, accelerating the response time and accuracy of threat detection. This predictive capability can enable the system to proactively present contextual insights and recommendations, tailored to the unique characteristics of each security event.

These historical data aggregation and predictive analysis techniques can streamline operations and can enhance the ability to detect and respond to novel threats. Furthermore, the system incorporates a sophisticated dialogue management framework that uses tokenized queries and actions derived from historical interactions.

Each tokenized element can be associated with specific operations performed during past incidents, enabling the cybersecurity incident management system to articulate detailed narratives about the nature of a detected threat, the investigatory actions taken, and the suggested next steps for the customer and/or security analyst user. A dialogue-based interaction model can provide users with a clear understanding of what each type of detection signifies, the actions undertaken on their behalf, and measures they should consider.

The tokenization of queries and actions ensures that sensitive data is handled securely, while also maintaining the integrity and confidentiality of user data throughout the process. A customer experience is improved by making security operations more explainable (e.g., using explainable artificial intelligence), transparent, educational, and user-centric.

Referring to the feature layout 500, an example enhanced cybersecurity incident management system leverages advanced query and interaction capabilities, archives query histories, analyzes patterns in cybersecurity cases, leverages machine learning algorithms, predicts and categorizes incident types, accelerates threat detection and response time, and presents contextual insights and recommendations.

Further, the example enhanced cybersecurity incident management system incorporates a sophisticated dialogue management framework, utilizes tokenized queries and actions, associates tokens with specific operations, articulates detailed narratives, describes threat, investigatory actions, and suggested next steps, improves customer experience, and provides security operations that are transparent, educational, and user-centric.

Further, the example enhanced cybersecurity incident management system integrates a retrieval augmented architecture (RAG). The RAG includes AI/ML agents that optimize path to resolve incidents, and privacy preserving tokenization features. The privacy preserving tokenization features can be based on knowledge bases such as ticketing systems, forensics systems, collaboration tools, etc.

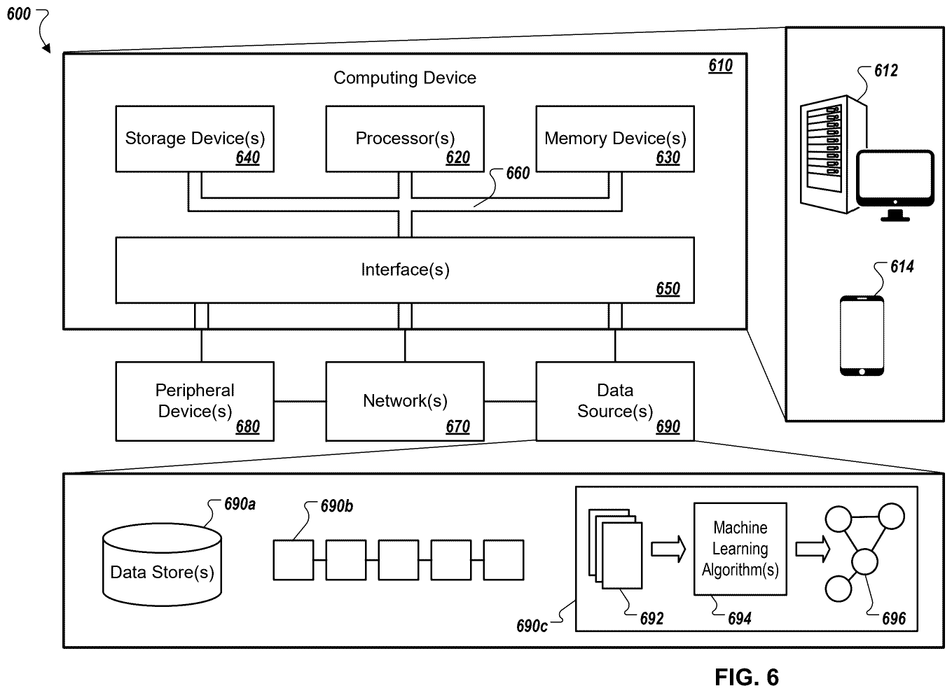

FIG. 6 is a schematic diagram that shows an example of a computing system 600 that can be used to implement the techniques described herein. The computing system 600 includes one or more computing devices (e.g., computing device 610), which can be in wired and/or wireless communication with various peripheral device(s) 680, data source(s) 690, and/or other computing devices (e.g., over network(s) 670). The computing device 610 can represent various forms of stationary computers 612 (e.g., workstations, kiosks, servers, mainframes, edge computing devices, quantum computers, etc.) and mobile computers 614 (e.g., laptops, tablets, mobile phones, personal digital assistants, wearable devices, etc.). In some implementations, the computing device 610 can be included in (and/or in communication with) various other sorts of devices, such as data collection devices (e.g., physical or virtual devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 610, and an entire system can be made up of multiple devices communicating with each other. For example, the computing device 610 can be part of a computing system that includes a network of computing devices, such as a cloud-based computing system, a computing system in an internal network, or a computing system in another sort of shared network. Processors of the computing device (610) and other computing devices of a computing system can be optimized for different types of operations, secure computing tasks, etc. The components shown herein, and their functions, are meant to be examples, and are not meant to limit implementations of the technology described and/or claimed in this document.

The computing device 610 includes processor(s) 620, memory device(s) 630, storage device(s) 640, and interface(s) 650. Each of the processor(s) 620, the memory device(s) 630, the storage device(s) 640, and the interface(s) 650 are interconnected using a system bus 660. The processor(s) 620 are capable of processing instructions for execution within the computing device 610, and can include one or more single-threaded and/or multi-threaded processors. The processor(s) 620 are capable of processing instructions stored in the memory device(s) 630 and/or on the storage device(s) 640. The memory device(s) 630 can store data within the computing device 610, and can include one or more computer-readable media, volatile memory units, and/or non-volatile memory units. The storage device(s) 640 can provide mass storage for the computing device 610, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 650 can include various communications interfaces (e.g., USB, Near-Field Communication (NFC), Bluetooth, WiFi, Ethernet, wireless Ethernet, etc.) that can be coupled to the network(s) 670, peripheral device(s) 680, and/or data source(s) 690 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 650 can include a control interface that receives commands from an input device (e.g., operated by a user) and converts the commands for submission to the processors 620. The interface(s) 650 can include a display interface that includes circuitry for driving a display to present visual information to a user. The interface(s) 650 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 670 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 610 can communicate with the peripheral device(s) 680, the data source(s) 690, and/or other computing devices over the network(s) 670. In some implementations, the computing device 610 can directly communicate with the peripheral device(s) 680, the data source(s), and/or other computing devices.

The peripheral device(s) 680 can provide input/output operations for the computing device 610. Input devices (e.g., keyboards, pointing devices, touchscreens, microphones, cameras, scanners, sensors, etc.) can provide input to the computing device 610 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 610 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 690 can provide data for use by the computing device 610, and/or can maintain data that has been generated by the computing device 610 and/or other devices (e.g., data collected from sensor devices, data aggregated from various different data repositories, etc.). In some implementations, one or more data sources can be hosted by the computing device 610 (e.g., using the storage device(s) 640). In some implementations, one or more data sources can be hosted by a different computing device. Data can be provided by the data source(s) 690 in response to a request for data from the computing device 610 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 690a (e.g., databases, or other sorts of data management systems). The data store(s) can be provided by a single computing device or network or provided by multiple distributed computing devices or networks (e.g., hosted by a computer cluster, hosted in cloud storage, etc.). In some implementations, a database management system (DBMS) can be included to provide access to data contained in database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 690b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 690c. The machine learning system(s) 690c, for example, can be used to analyze data from various sources (e.g., data provided by the computing device 610, data from the data store(s) 690a, data from the blockchain(s) 690b, and/or data from other data sources), to identify patterns in the data, and to draw inferences from the data patterns. In general, training data 692 can be provided to one or more machine learning algorithms 694, and the machine learning algorithm(s) can generate a machine learning model 696. Execution of the machine learning algorithm(s) can be performed by the computing device 610, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a model optimization (e.g., training, refining, fine-tuning) process, or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A cybersecurity system for summarizing network security investigations, comprising:
at least one processor; and
memory storing instructions, that, when executed by the at least one processor, cause the system to perform operations comprising:
receiving a request to summarize an investigation sequence performed in response to a computer security incident;
retrieving a set of tokenized elements that correspond to the investigation sequence;
providing each tokenized element in the set of tokenized elements to a large language model (LLM) for translation into a data operation format;
receiving, from the LLM, and for each tokenized element in the set of tokenized elements, a corresponding translated data operation;
for each translated data operation in a set of translated data operations, (i) submitting the translated data operation for execution by a data source, and (ii) receiving a corresponding data operation response;
performing a summarization process of the investigation sequence, based at least in part on the set of tokenized elements and on a set of corresponding data operation responses; and
outputting a natural language summarization of the investigation sequence, based on the summarization process.

2. The system of claim 1, the operations further comprising:
refining the LLM such that the LLM is configured to translate natural language commands into the data operation format, wherein the refining is based at least in part on (i) a data schema of security incident data maintained by the data source, (ii) a data operation syntax employed by the data source, and (iii) data that represents historical security investigations and their associated data operations.

3. The system of claim 1, wherein the set of tokenized elements includes natural language questions and/or natural language actions.

4. The system of claim 3, wherein the summarization process comprises:
providing each data operation response in the set of data operation responses to the LLM for translation into a corresponding natural language response;
aggregating the set of tokenized elements and a corresponding set of natural language responses;
providing the aggregated tokenized elements and corresponding natural language responses to the LLM for summarization; and
receiving, from the LLM, the natural language summarization of the investigation sequence.

5. The system of claim 4, wherein a technical complexity of the natural language summarization of the investigation sequence is adaptively adjusted by the LLM to reflect a technical expertise and/or security privileges of a user from whom the request to summarize an investigation sequence is received.

6. The system of claim 1, wherein the request to summarize the investigation sequence performed in response to the computer security incident is received through a visual interface, and the natural language summarization of the investigation sequence is returned through the visual interface.

7. The system of claim 6, wherein the visual interface is a text service that supports multi-turn conversations about the computer security incident.

8. The system of claim 1, the operations further comprising:
mapping the corresponding data operation response to a corresponding security insight.

9. The system of claim 1, the operations further comprising storing the natural language summarization of the investigation sequence, along with information that pertains to a case type of the investigation sequence.

10. The system of claim 9, wherein the information that pertains to the case type of the investigation sequence comprises a typical predicted analysis pattern for the case type.

11. A computer-implemented method for summarizing network security investigations, the method comprising:
receiving a request to summarize an investigation sequence performed in response to a computer security incident;
retrieving a set of tokenized elements that correspond to the investigation sequence;
providing each tokenized element in the set of tokenized elements to a large language model (LLM) for translation into a data operation format;
receiving, from the LLM, and for each tokenized element in the set of tokenized elements, a corresponding translated data operation;
for each translated data operation in a set of translated data operations, (i) submitting the translated data operation for execution by a data source, and (ii) receiving a corresponding data operation response;
performing a summarization process of the investigation sequence, based at least in part on the set of tokenized elements and on a set of corresponding data operation responses; and
outputting a natural language summarization of the investigation sequence, based on the summarization process.

12. The computer-implemented method of claim 11, further comprising:
refining the LLM such that the LLM is configured to translate natural language commands into the data operation format, wherein the refining is based at least in part on (i) a data schema of security incident data maintained by the data source, (ii) a data operation syntax employed by the data source, and (iii) data that represents historical security investigations and their associated data operations.

13. The computer-implemented method of claim 11, wherein the set of tokenized elements includes natural language questions and/or natural language actions.

14. The computer-implemented method of claim 13, wherein the summarization process comprises:
providing each data operation response in the set of data operation responses to the LLM for translation into a corresponding natural language response;
aggregating the set of tokenized elements and a corresponding set of natural language responses;
providing the aggregated tokenized elements and corresponding natural language responses to the LLM for summarization; and
receiving, from the LLM, the natural language summarization of the investigation sequence.

15. The computer-implemented method of claim 14, wherein a technical complexity of the natural language summarization of the investigation sequence is adaptively adjusted by the LLM to reflect a technical expertise and/or security privileges of a user from whom the request to summarize an investigation sequence is received.

16. The computer-implemented method of claim 11, wherein the request to summarize the investigation sequence performed in response to the computer security incident is received through a visual interface, and the natural language summarization of the investigation sequence is returned through the visual interface.

17. The computer-implemented method of claim 16, wherein the visual interface is a text service that supports multi-turn conversations about the computer security incident.

18. The computer-implemented method of claim 11, further comprising:
mapping the corresponding data operation response to a corresponding security insight.

19. The computer-implemented method of claim 11, further comprising storing the natural language summarization of the investigation sequence, along with information that pertains to a case type of the investigation sequence.

20. The computer-implemented method of claim 19, wherein the information that pertains to the case type of the investigation sequence comprises a typical predicted analysis pattern for the case type.
